(19) United States
(12) Patent Application Publication
(10) Pub. No.: US 2010/0086462 A1
(43) Pub. Date: Apr. 8, 2010

(54) Nanoscale phosphates

(75) Inventors: Joachim Markmann, Dorsheim (DE); Ruediger Wissemborski, Gau-Algesheim (DE); Christian Kohlpaintner, Ingelheim (DE); Gerhard Scheuer, Nieder-Olm (DE); Erhard Fischer, Ingelheim (DE); Wolfgang Mueller, Ingelheim (DE)

Correspondence Address: MICHAEL L. DUNN, SIMPSON & SIMPSON, PLLC, 5555 MAIN STREET, WILLIAMSVILLE, NY, 14221, US

(73) Assignee: Chemische Fabrik Budenheim KG, Budenheim (DE)

(21) Appl. No.: 12/309,334

(22) PCT Filed: Jul. 10, 2007
(86) PCT No.: PCT/EP2007/057057

§ 371 Date: Nov. 13, 2009

(30) Foreign Application Priority Data
Jul. 18, 2006 (DE) 10 2006 033 152.4

(51) Int. Cl. C01B 25/32; C01B 25/26; C01B 25/36; C01B 25/30

(52) U.S. Cl. 423/309; 423/305; 423/311; 423/314; 977/773

(57) ABSTRACT

A process for the production of nanofine metal phosphates including the steps of: preparing a solution containing metal cations, phosphate anions and organic carboxylic acid, and finely spraying the solution in a reactor at a temperature above 100 degrees C. wherein the temperature is selected to vaporize the organic acid, and water if present, to obtain nanofine metal phosphate particles.

### BACKGROUND OF THE INVENTION

The present invention relates to a process for the production of nanofine metal phosphates and also to the nanofine metal phosphates which are producible or produced by the process and to the use thereof.

Recently, very fine solid materials having average particle sizes of less than 500 nm, known as nanoparticles, have become increasingly important and are used in a broad range of areas such as, for example, dentistry, medicine, pharmaceutics or the production of magnetic storage media.

Atoms or molecules at the surface of a particle generally have different physical and chemical properties to corresponding atoms or molecules inside the material. The lower the particle size of a solid material, the larger the specific surface area thereof and the higher its content of surface atoms or molecules. Nanoparticulate materials can therefore have quite different mechanical, electronic, chemical and/or visual properties to the corresponding materials having larger particle sizes or to solid material. On account of their large number of surface atoms or molecules and their large specific surface area, nanoparticles can be extremely reactive and bond to other substances more rapidly than materials having higher particle sizes. These properties open up a broad range of new applications for nanoparticles. In many cases, the material properties of nanoparticles may be varied directly by selecting the average particle size and/or the particle size distribution.

For the production of nanoparticles there are various known processes which, depending on the nature of the material, the chemical composition and the starting substances, are more or less suitable for the production of nanoparticles and, depending on the nature of the material, also provide differing particle sizes and product properties.

Known processes include the mechanical grinding of solids, the precipitation of nanoparticulate particles from a solution and the production of nanoparticulate metal oxides by flame oxidation of other metal compounds. However, many production processes are complex and highly cost-intensive and require expensive and complex technology. In many cases, the product purity is insufficient for specific applications of the nanoparticles or complex purification processes are required in order to achieve a desired degree of purity. Some processes, such as for example the grinding of solids, are extremely limited in terms of the particle sizes which may be achieved or require a procedure which is technically very complex and tedious for the production of very fine particles.

A number of known processes are concerned with the production of nanoparticulate metal phosphates, in particular calcium phosphates, which are used, for example, in dentistry. These processes also either are very complex or do not provide the desired product purity or the desired particle sizes.

### BRIEF DESCRIPTION OF THE INVENTION

The object of the present invention was to overcome the aforementioned drawbacks of the prior art and to provide an improved process for the production of nanoscale (nanofine) phosphates. In particular, the object of the present invention was to provide a simple process for the production of the aforementioned nanofine phosphates wherein the nanoparticles have desired particle sizes and particle size distributions and a high degree of purity without undesirable impurities.

According to the invention, this object is achieved by a process for the production of nanofine metal phosphates.

More particularly, the invention includes a process for the production of nanofine metal phosphates including the steps of:

preparing a solution containing metal cations, phosphate anions and organic carboxylic acid, and finely spraying the solution in a reactor at a temperature above 100 degrees C. wherein the temperature is selected to vaporize the organic acid, and water if present, to obtain nanofine metal phosphate particles.

The process may include the stages in which

a) there is prepared a solution containing the following:

a1) a compound containing the metal cation or a mixture of compounds containing
a plurality of metal cations,
phosphoric acid (H₃PO₄),
an organic carboxylic acid and
water, or

a2) a phosphate compound of the metal cation or phosphate compounds of various metal cations,
an organic carboxylic acid and water, and
   b) the solution is finely sprayed in a reactor at a temperature of above 100° C., wherein the temperature is selected in such a way that the organic acid and the water evaporate out of the solution so as to obtain nanofine particles.

### DETAILED DESCRIPTION OF THE INVENTION

In the process according to the invention, the compound containing the metal cation is preferably first of all dissolved in the organic carboxylic acid or a mixture of the organic carboxylic acid and the water. It has been found that the organic carboxylic acid keeps the metal cation especially well dissolved in a solution comprising phosphoric acid and water or in a solution of the phosphate compound of the metal cation and water. If the phosphoric acid is added, it is preferably mixed in with the metal compound dissolved in organic carboxylic acid or in a mixture of the organic carboxylic acid and the water and provides the phosphate content of the target compounds to be produced in nanofine size. Use is expediently made of aqueous phosphoric acid, such as for example 75% phosphoric acid, thus providing the entire amount or a portion of the amount of the water of the solution according to stage a). The important thing is that the solution of stage a) of the process according to the invention is a clear solution without cloudiness or precipitation before being fed to stage b) of the process according to the invention.

In stage b) of the process according to the invention, the solution is finely sprayed in a reactor at a temperature above 100° C., drying with evaporation of the organic acid and the water and optionally condensation of the phosphate molecules so as to obtain the desired nanofine particles being carried out in an extremely short period of time. Reactors suitable for spray drying processes of this type are known per se. According to the invention, the reactor for the process is particularly preferably a fluidised bed reactor.

The temperature of the spray drying in the process according to the invention is to be selected so as to produce nanoparticulate metal phosphates in the reactor. Particularly preferably, the conditions are selected in such a way that the nanofine particles have an average particle size of less than 200 nm, preferably of less than 150 nm, more preferably of less than 100 nm, particularly preferably of from 20-80 nm, most particularly preferably of from 30-50 nm. The nanoparticulate metal phosphates produced by the process according to the invention may be in the form of water-like agglomerates or of individual particles.

The grain sizes or the average particle sizes of the nanoparticles according to the invention can be measured by scanning electron microscopy (SEM), calculation of the specific surface area (BET) and/or dynamic light scattering (DLS).

According to the invention, the organic carboxylic acid used in the process is particularly preferably formic acid (HCOOH) or acetic acid (H₃C—COOH). Most particularly preferred is formic acid. In the process according to the invention, formic acid and acetic acid have the advantage of keeping the compound containing the metal cation well dissolved in the starting solution from stage a) and, at the same time, of evaporating very rapidly at a relatively low temperature owing to their low boiling point for organic carboxylic acids. The lower the concentration of the phosphate-forming components and the more rapidly the organic carboxylic acid and the water evaporate, the lower the particle sizes which can be achieved. In the process according to the invention, the temperature may advantageously be kept relatively low compared to known flame oxidation processes, for example in the range of from 100-600° C., preferably in the range of from 250-500° C., particularly preferably in the range of from 300-400° C. This rules out the risk of oxidation of the metal or of the compound containing the metal cation, and this is precisely the aim in the production of nanoparticulate metal oxides during flame oxidation.

In a preferred embodiment of the invention, the nanofine metal phosphates are selected from the group consisting of nanofine metal orthophosphates and nanofine condensed metal phosphates.

In a particularly preferred embodiment of the invention, the nanofine metal phosphates are selected from the group consisting of nanofine alkali orthophosphates, nanofine alkaline-earth orthophosphates, nanofine orthophosphates of metals from subgroups I to VIII of the periodic table, nanofine condensed alkali phosphates, nanofine condensed alkaline-earth phosphates and nanofine condensed phosphates of metals from subgroups I to VIII of the periodic table. Most particularly preferably, the nanofine metal phosphates are selected from the group consisting of nanofine calcium, magnesium, aluminium, iron, copper and zinc orthophosphates and nanofine condensed sodium, potassium, calcium, magnesium, aluminium, iron, copper and zinc phosphates.

In a further particularly preferred embodiment of the invention, the nanofine metal phosphates are selected from the group consisting of nanofine tertiary calcium, magnesium, aluminium, iron, copper and zinc phosphates and nanofine calcium, magnesium, iron, copper and zinc pyrophosphates. Most preferably, the nanofine metal phosphates are in this case selected from the group consisting of nanofine tricalcium phosphate (hydroxyl apatite; Ca₅(PO₄)₃OH), nanofine β-tricalcium phosphate (Ca₃(PO₄)₂), nanofine aluminium phosphate (AlPO₄), nanofine iron phosphate (FePO₄), nanofine copper hydroxide phosphate, nanofine copper phosphate (Cu₃(PO₄)₂), nanofine calcium pyrophosphate (Ca₂P₂O₇), nanofine magnesium pyrophosphate (Mg₂P₂O₇), nanofine iron pyrophosphate (Fe₄(P₂O₇)₃), nanofine copper pyrophosphate (Cu₂P₂O₇) and nanofine zinc pyrophosphate (Zn₂P₂O₇).

In a further particularly preferred embodiment of the invention, the nanofine metal phosphates are selected from the group consisting of nanofine sodium polyphosphate and nanofine potassium polyphosphate, preferably (NaPO₃)ₙ or (KPO₃)ₙ.

The composition according to the invention of the starting solution according to stage a) of the process according to the invention allowed the production of metal phosphates of the aforementioned type to be substantially simplified and improved and production costs to be reduced. In earlier methods for the production of metal phosphates, especially of hydroxyl apatite, there was always the problem that the target compounds precipitated as soon as the metal cations and the phosphate source combined in the starting solution for spray drying, so it was impossible to control the particle size or the starting solution could not even be used for further spray drying. In the past, this problem, especially the problem of the precipitation of hydroxyl apatite in the starting solution, was avoided by preparing the metal cation and the phosphate source in separate starting solutions and spraying them through two different nozzles into a reactor chamber where they combined to form the desired phosphate which was dried with the formation of fine particles. Controlling the combining and the reaction of the metal cations and the phosphate source was technically complex and difficult as in the reactor chamber, firstly, an adequate reaction or congregation of the metal cations and phosphate source had to be achieved and, at the same time, the drying conditions such as temperature, throughput, etc. had to be set in such a way as to allow rapid drying, so the particles obtained had the desired nanoparticulate size. The process of the present invention overcomes these high production costs and the difficulties in terms of control. Furthermore, the process according to the invention provides a purer product as, according to the earlier process, the product could, if the process control were not optimal, be contaminated with the compound containing the metal cation.

In the process according to the invention, it is expedient if the solution in stage a) contains the compound containing the metal cation in a concentration of from 0.1 to 20% by weight, preferably from 1.5 to 15% by weight, particularly preferably from 2 to 5% by weight.

In the process according to the invention, it is also expedient if the solution in stage a1) contains the phosphoric acid in a concentration of from 0.1 to 20% by weight, preferably from 1 to 10% by weight, particularly preferably from 1 to 5% by weight and most particularly preferably of approximately 3% by weight.

In the process according to the invention, it is also expedient if the solution in stage a) contains the organic carboxylic acid in a concentration of from 10 to 99% by weight, preferably of from 20 to 95% by weight, particularly preferably of approximately 80% by weight.

In a particularly preferred embodiment of the process according to the invention, the compound containing the metal cation in stage a1) is selected from metal carbonate, metal hydroxide, metal oxide hydroxide, metal hydroxide carbonate, metal phosphate, metal silicate, metal sulphate, metal nitrate, metal oxide, metal carboxylate and metal acetyl acetonate and mixtures thereof. Other metal compounds soluble in the organic acid are also suitable. Particularly preferably, the compound containing the metal cation in stage a1) is the metal carbonate or metal hydroxide.

The invention also relates to nanofine phosphate, preferably nanofine tricalcium phosphate (hydroxyl apatite), nanofine aluminium phosphate, nanofine iron phosphate or nanofine copper hydroxide phosphate producible or produced by the process according to the invention. The nanoparticulate phosphates according to the invention differ from nanoparticles produced in the known manner by precipitation in that they may be obtained with a substantially higher degree of purity. Compared to finely ground phosphates, the nanofine metal phosphates produced in accordance with the invention are distinguished by the finer particle sizes which may be achieved. In the past, a large number of nanofine phosphates, such as nanofine aluminium phosphate, iron phosphate or copper hydroxide phosphate, were not even produced in the prior art.

Furthermore, the invention relates to the use of nanofine phosphates according to the invention for the production of artificial bone material and/or for the production of dental fillings, for the production of flame retardants, as pigments for the production of plastics materials inscribable by laser light or plastics materials weldable by laser light, for the production of ceramic surfaces, for the production of illuminants and/or as an excipient for medical contrast media.

Suitable, for example, is a mixture of 10% by weight of nanofine copper hydroxide phosphate according to the invention and 90% by weight graphite as a pigment for the laser inscription of plastics materials. For this purpose, 1% by weight of the aforementioned mixture is, for example, incorporated into polyethylene plastics material. The polymer thus obtained can be inscribed using an NdYAG laser so as to obtain a white inscription on a dark base.

Further advantages, features and possible embodiments of the process according to the invention and the metal phosphates according to the invention will be described in greater detail hereinafter using the following examples.

### EXAMPLES

### Characterisation of Nanofine Particles

The grain sizes or the average particle sizes of the nanoparticles according to the invention were measured by scanning electron microscopy (SEM) at 15 kV and at an enlargement factor of 55,000 using a device from Zeiss.

### Calculation of the Specific Surface Area of Nanofine Particles

The specific surface area of nanofine particles was calculated by multipoint BET measurements in a sorption device from Quantachrome GmbH, Germany (NOVA 1000 model) in accordance with the manufacturer's instructions. The measurement gas used was nitrogen.

### Example 1

### Production of Nanofine Tricalcium Phosphate (Hydroxyl Apatite)

There was produced a starting solution having the following composition:

| | |
|---|---|
| CaO | 1.8% by weight |
| Formic acid | 85.7% by weight |
| Phosphoric acid (75%) | 2.5% by weight |
| Water | 10.0% by weight |

First of all, the CaO was dissolved in the formic acid. Then the phosphoric acid and the water were added and the solution was mixed thoroughly. The clear solution was sprayed in a fluidised bed reactor at a temperature of 380° C.

The product was nanofine tricalcium phosphate having an average particle size of from 30 to 50 nm, a specific weight of 90 g/1 and a specific surface area of 130 m²/g.

### Example 2

### Production of Nanofine Tricalcium Phosphate (Hydroxyl Apatite)

There was produced a starting solution having the following composition:

| | |
|---|---|
| Ca(OH)₂ | 1.8% by weight |
| Acetic acid | 72.9% by weight |
| Phosphoric acid (75%) | 2.5% by weight |
| Water | 22.8% by weight |

First of all, the Ca(OH)₂ was dissolved in the acetic acid. Then the phosphoric acid and the water were added and the solution was mixed thoroughly. The clear solution was sprayed in a fluidised bed reactor at a temperature of 350° C.

The product was nanofine tricalcium phosphate having an average particle size of 50 nm, a specific weight of 85 g/1 and a specific surface area of 132 m²/g.

### Example 3

### Production of Nanofine Aluminium Phosphate

There was produced a starting solution having the following composition:

| | |
|---|---|
| Al(OH)₃ | 1.5% by weight (in the moist filter cake) |
| Formic acid | 70.0% by weight |
| Phosphoric acid (75%) | 2.0% by weight |
| Water | 13.0% by weight |

First of all, the Al(OH)₃ was dissolved in the formic acid. Then the phosphoric acid and the water were added and the solution was mixed thoroughly. The clear solution was sprayed in a fluidised bed reactor at a temperature of 380° C.

The product was nanofine aluminium phosphate having an average particle size of from 30 to 50 nm, a specific weight of 140 g/l and a specific surface area of 29.7 m²/g.

### Example 4

### Production of Nanofine Copper Hydroxide Phosphate

There was produced a starting solution having the following composition:

| | |
|---|---|
| Cu(OH)₂ | 7.0% by weight |
| Formic acid | 33.0% by weight |
| Phosphoric acid (75%) | 4.2% by weight |
| Water | 55.8% by weight |

First of all, the Cu(OH)₂ was dissolved in the formic acid. Then the phosphoric acid and the water were added and the solution was mixed thoroughly. The clear solution was sprayed in a fluidised bed reactor at a temperature of 220° C.

The product was nanofine copper hydroxide phosphate having an average particle size of 40 nm, a specific weight of 90 g/l and a specific surface area of 35 m²/g.

### Example 5

### Production of Nanofine Potassium Metaphosphate

There was produced a starting solution having the following composition:

| | |
|---|---|
| KH₂PO₄ | 3.0% by weight |
| Acetic acid | 82.5% by weight |
| Water | 14.5% by weight |

The mixture of acetic acid and water was provided and the potassium phosphate then dissolved therein. The clear solution obtained was sprayed in a fluidised bed reactor at a temperature of 350° C.

The product was nanofine potassium metaphosphate having an average particle size of 50 nm, a specific weight of 140 g/l and a specific surface area of 50 m²/g.

What is claimed is:

1-17. (canceled)

18. A process for the production of nanofine metal phosphates including the steps of: preparing a solution containing metal cations, phosphate anions and organic carboxylic acid, and finely spraying the solution in a reactor at a temperature above 100 degrees C. wherein the temperature is selected to vaporize the organic acid, and water if present, to obtain nanofine metal phosphate particles.

19. The process of claim 19 wherein the solution is prepared by introducing a compound or mixture of compounds that provide metallic cations into the solution.

20. The process of claim 19 wherein the solution is prepared by introducing phosphoric acid to provide phosphate ions.

21. The process of claim 19 wherein the solution is prepared by introducing water into the solution.

22. The process according to claim 19 wherein the nanofine metal phosphates are selected from the group consisting of nanofine metal orthophosphates and nanofine condensed metal phosphates.

23. The process according to claim 19 wherein the metal cations, phosphate anions and organic carboxylic acid in the solution are selected to obtain nanofine metal phosphates selected from the group consisting of nanofine alkali orthophosphates, nanofine alkaline-earth orthophosphates, nanofine orthophosphates of metals from subgroups I to VIII of the periodic table, nanofine condensed alkali phosphates, nanofine condensed alkaline-earth phosphates and nanofine condensed phosphates of metals from subgroups Ito VIII of the periodic table.

24. The process according to claim 19 wherein the metal cations, phosphate anions and organic carboxylic acid in the solution are selected to obtain nanofine metal phosphates selected from the group consisting of nanofine calcium, magnesium, aluminium, iron, copper and zinc orthophosphates and nanofine condensed sodium, potassium, calcium, magnesium, aluminium, iron, copper and zinc phosphates.

25. The process according to claim 19 wherein the metal cations, phosphate anions and organic carboxylic acid in the solution are selected to obtain nanofine metal phosphates selected from the group consisting of nanofine tertiary calcium, magnesium, aluminium, iron, copper and zinc phosphates and nanofine calcium, magnesium, iron, copper and zinc pyrophosphates.

26. The process according to claim 19 wherein the metal cations, phosphate anions and organic carboxylic acid in the solution are selected to obtain nanofine metal phosphates selected from the group consisting of nanofine tricalcium phosphate (hydroxyl apatite; Ca₅(PO₄)₃OH), nanofine β-tricalcium phosphate (Ca₃(PO₄)₂), nanofine aluminium phosphate (AlPO₄), nanofine iron phosphate (FePO₄), nanofine copper hydroxide phosphate, nanofine copper phosphate (Cu₃(PO₄)₂), nanofine calcium pyrophosphate (Ca₂P₂O₇), nanofine magnesium pyrophosphate (Mg₂P₂O₇), nanofine iron pyrophosphate (Fe₄(P₂O₇)₃), nanofine copper pyrophosphate (Cu₂P₂O₇) and nanofine zinc pyrophosphate (Zn₂P₂O₇).

27. The process according to claim 19 wherein the metal cations, phosphate anions and organic carboxylic acid in the solution are selected to obtain nanofine metal phosphates selected from the group consisting of nanofine sodium polyphosphate and nanofine sodium polyphosphate (NaPO₃)ₙ or nanofine potassium polyphosphate (KPO₃)ₙ.

28. The process according to claim 19 wherein the organic acid is formic acid (HCOOH) or acetic acid (H₃C—COOH).

29. The process according to claim 19 wherein the temperature is in the range of from 100 to 600° C.

30. The process according to claim 19 wherein the temperature is in the range of from 250 to 500° C.

31. The process according to claim 19 wherein the temperature is in the range of from 300 to 400° C.

32. The process according to any claim 19 wherein the reactor is a fluidized bed reactor.

33. The process according to claim 19 wherein the nanofine particles have an average particle size of less than 200 nm.

34. The process according to claim 19 wherein the nanofine particles have an average particle size of less than 100 nm.

35. The process according to claim 19 wherein the nanofine particles have an average particle size of from 20 to 80 nm.

36. The process according to claim 19 wherein the solution contains a compound or mixture of compounds, providing the metal cations, in a concentration of from 1.5 to 15% by weight.

37. The process according to claim 19 wherein the solution contains phosphoric acid in a concentration of from 1 to 5% by weight.

38. The process according to claim 19 wherein the solution contains the organic carboxylic acid in a concentration of from 20 to 95% by weight.

39. The process according to claim 20 wherein the compound or mixture of compounds that provide metallic cations into the solution are selected from metal carbonate, metal hydroxide, metal oxide hydroxide, metal hydroxide carbonate, metal phosphate, metal silicate, metal sulphate, metal nitrate, metal oxide, metal carboxylate and metal acetyl acetonate and mixtures thereof.

40. A nanofine phosphate produced by the process of claim 19.

41. A process for the production a phosphate containing structure selected from artificial bone material, dental fillings, flame retardants, pigments for plastic materials inscribable by laser light, plastic materials weldable by laser light, ceramic surfaces for the production of illuminants and excipients for medical contrast media using a nanophosphate produced in accordance with claim 19.
